(19) United States
(12) Patent Application Publication
(10) Pub. No.: US 2024/0381161 A1
(43) Pub. Date: Nov. 14, 2024

(54) RADIO ACCESS RETRANSMISSION CONTROL

(71) Applicant: Nokia Technologies Oy, Espoo (FI)

(72) Inventors: Benoist Pierre SEBIRE, Tokyo (JP); Klaus Ingemann PEDERSEN, Aalborg (DK); Zexian LI, Espoo (FI)

(21) Appl. No.: 18/690,880

(22) PCT Filed: Oct. 14, 2021
(86) PCT No.: PCT/EP2021/078389

§ 371 Date: Mar. 11, 2024

(51) Int. Cl. H04W 28/02; H04W 28/04; H04W 76/25

(52) U.S. Cl. CPC H04W 28/0252; H04W 28/0236; H04W 28/04; H04W 76/25

(57) ABSTRACT

According to an example aspect of the present invention, there is provided a method comprising: buffering a first radio link control, RLC, data unit of a radio bearer for transmission to a receiving device, starting a retransmission timer responsive to providing the first RLC data unit for transmission to the receiving device, and retransmitting the buffered first RLC data unit in response to a request for a second RLC data unit of the radio bearer before expiry of the retransmission timer, wherein the second RLC data unit is to be transmitted to the receiving device after the first RLC data unit.

### FIELD

Various example embodiments relate to controlling radio access retransmissions.

### BACKGROUND

There are new applications for wireless domain having increasingly higher reliability requirements, as well as strict latency requirements. Extended reality (XR) refers to all real-and-virtual combined environments and associated human-machine interactions generated by computer technology and wearables. It includes representative forms such as augmented reality (AR), mixed reality (MR), and virtual reality (VR) and the areas interpolated among them. Due to high reliability requirements, resource efficient radio protocol retransmissions are needed for XR services.

### SUMMARY

According to some aspects, there is provided the subject matter of the independent claims. Some embodiments for some or all of the aspects are defined in the dependent claims.

According to a first aspect, there is provided a method, comprising: buffering a first radio link control, RLC, data unit of a radio bearer for transmission to a receiving device, starting a retransmission timer responsive to providing the first RLC data unit for transmission to the receiving device, and retransmitting the buffered first RLC data unit in response to a request for a second RLC data unit of the radio bearer before expiry of the retransmission timer, wherein the second RLC data unit is to be transmitted to the receiving device after the first RLC data unit.

According to a second aspect, there is provided an apparatus, comprising means configured for performing the method of the first aspect, or an embodiment thereof. The means may comprise one or more processors and memory comprising instructions, when executed by the one or more processors, cause the apparatus to perform the method.

According to further aspects, there is provided an apparatus, comprising one or more processors and memory comprising instructions, when executed by the one or more processors, cause the apparatus to perform the method of the first aspect, or an embodiment thereof.

The apparatus of any of the aspects may be a radio access network device, a terminal device, or for/comprised by such device. The radio access network device may be a next generation NodeB and the terminal device may be a User Equipment, for example.

According to still further aspects, there is provided a computer program product, a computer readable medium, or a non-transitory computer readable medium comprising program instructions for causing, when executed in a processor of an apparatus, the apparatus to perform the method according to any one of the above aspects or embodiments thereof.

### BRIEF DESCRIPTION OF THE DRAWINGS

FIG. 1 illustrates an example of a wireless communications system;

FIGS. 2a and 2b illustrate a radio access protocol architecture according to some example embodiments;

FIGS. 3 to 7 illustrate methods in accordance with at least some example embodiments; and

FIG. 8 illustrates an example apparatus capable of supporting at least some embodiments.

### DETAILED DESCRIPTION

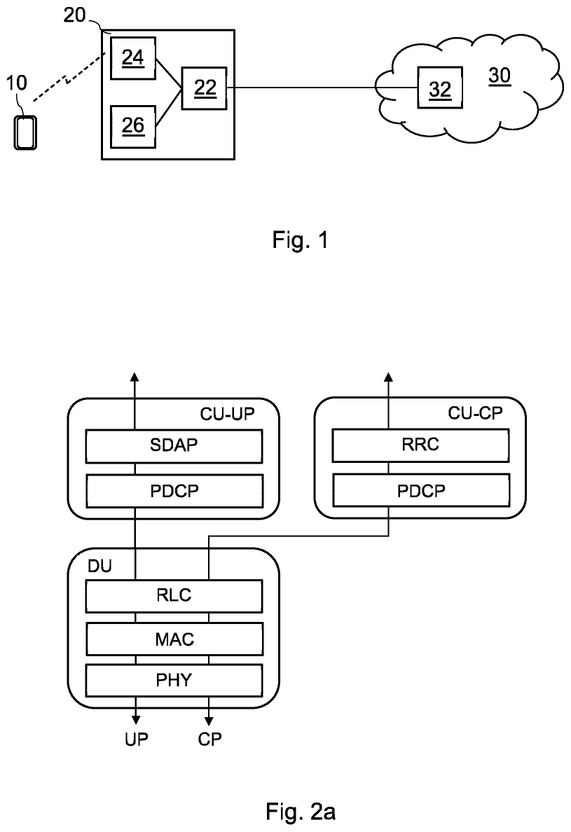

FIG. 1 illustrates a simplified example wireless communications system. A user equipment (UE) 10 communicates wirelessly with a wireless radio or access network portion or node, hereafter referred to as AN, 20, such as a NodeB, an evolved NodeB (eNB), a next generation (NG) NodeB (gNB), a base station, an access point, or other suitable wireless/radio access network (RAN) device or system.

The UE 10 may attach or register to the AN 20 for wireless communications. The air interface between UE and AN may be configured in accordance with a Radio Access Technology, RAT, which both the UE 10 and AN 20 are configured to support.

Examples of cellular RATs include Long Term Evolution, LTE, New Radio, NR, which is also known as fifth generation, 5G, and MulteFire. An example of non-cellular RATs includes wireless local area network, WLAN. Principles of the present disclosure are not limited to a specific RAT though. For example, in the context of NR, AN 20 may be a gNB, but in the context of another RAT, AN 20 may be another type of base station, access node or nodeB.

The AN 20 may comprise one or more operationally and/or physically separate sub-units or nodes 22, 24, 26 referred to below as nodes or logical RAN nodes. One of the nodes, in the present example (first) node 22, may be a node connected to further network(s), such as core network 30, and may control one or more other nodes 24. The controlling node 22 may be a central unit (CU) and the controlled node(s) 24, 26 may be distributed unit(s) (DU), such as the gNB-CU and gNB-DU connected over F1 interface of Third Generation Partnership Project (3GPP) 5G RAN, respectively. There are a plurality of options on how gNB functions may be split between the gNB-CU and gNB-DU.

The AN 20 may be connected, directly or via at least one intermediate node, with one or more devices or elements 32 of a core network 30, such as a Next Generation core network, Evolved Packet Core (EPC), or other network management element. The core network 30 may comprise a set of network functions. A network function may refer to an operational and/or physical entity. For example, the element 32 may be a network function or be configured to perform one or more network functions. The network function may be a specific network node or element, or a specific function or set of functions carried out by one or more entities, such as virtual network elements. Examples of such network functions include an access control or management function, mobility management or control function, session management or control function, data management or storage function, user plane function (UPF) authentication (or authentication server) function, application function (AF), or a combination of one or more of these functions.

For example, a 3GPP 5G core network comprises access and mobility management function (AMF), which may be configured to terminate RAN control plane (N2) interface and perform registration management, connection management, reachability management, mobility management, access authentication, access authorization, security anchor functionality (SEAF), security context management (SCM), and support for interface for non-3GPP access. A session management function (SMF) controls creation, updating and removing PDU sessions and manages session context with user plane function (UPF).

The core network 30 may be, in turn, coupled with another network (not shown), via which connectivity to further networks may be obtained, for example via a worldwide interconnection network. The AN 20 may be connected with at least one other AN as well via an inter-base station interface, particularly for supporting mobility of the UE 10, e.g. by 3GPP X2 or similar NG interface.

The UE 10 may be referred to as a user device or wireless terminal in general. Hence, without limiting to 3GPP User Equipment, the term user equipment is to be understood broadly to cover various mobile/wireless terminal devices, mobile stations and user devices for user communication and/or machine to machine type communication. The UE 10 may be or be comprised by, for example, a smartphone, a cellular phone, a Machine-to-Machine, M2M, node, machine-type communications node, an Internet of Things, IoT, node, a car telemetry unit, a laptop computer, a tablet computer or, indeed, another kind of suitable user device or mobile station, i.e., a terminal.

Additionally, although the apparatuses have been depicted as single entities, different units, processors and/or memory units (not all shown in FIG. 1) may be implemented inside these apparatuses, to enable the functioning thereof. The system may also be able to support the usage of cloud services, for example at least part of core network operations may be carried out as a cloud service. The communication system may also comprise a central control entity, or a like, providing facilities for networks of different operators to cooperate for example in spectrum sharing.

The system may be configured to support an XR application, such as an AR, VR, and/or MR application. The core network 30 may comprise an XR application function, such as a 5G-XR AF (5G AF dedicated to XR services), which may host XR media and media functions. The core network 30 may comprise an XR application server, such as a 5G-XR AS (5G AS dedicated to XR services). The UE 10 may comprise an XR client, such as a 5G-NR Client, which may comprise an XR engine (which may communicate with the XR application server to access XR data) and an XR session handler (which may communicate with the XR application function to control an XR session and with the XR session handler for XR session control). The core network may be connected to an XR application provider.

Edge Computing as a network architecture may be applied to provide XR and Cloud Gaming. Edge Computing is a concept that enables cloud computing capabilities and service environments to be deployed close to the cellular network. Edge Computing promises several benefits such as lower latency, higher bandwidth, reduced backhaul traffic and prospects for several new services. 5G NR is designed to support applications demanding high throughput and low latency in line with the requirements posed by the support of XR and Edge Computing applications in NR networks.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. For example, in a 5G cloud RAN, the DU's server and relevant software could be hosted on a site itself or can be hosted in an edge cloud (datacenter or central office) depending on transport availability and fronthaul interface. The CU's server and relevant software can be co-located with the DU or hosted in a regional cloud data center. One of the concepts for 5G networks is network slicing in which multiple independent and dedicated virtual sub-networks (network instances) may be created within the same infrastructure to run services that have different requirements on latency, reliability, throughput and mobility.

The depicted system is only an example of a part of a system and in practice, the system may comprise further access nodes, e.g. with the split CU-DU architecture, the user device may have an access to a plurality of radio cells and the system may comprise also other apparatuses, such as physical layer relay nodes or other core network functions or elements, etc. A cellular radio system may be implemented as a multilayer network including several kinds of cells, such as macrocells, microcells and picocells, for example. Typically, in multilayer networks, one access node provides one kind of a cell or cells, and thus a plurality of NodeBs are required to provide such a network structure. 5G may also utilize satellite communication to enhance or complement the coverage of 5G service, for example by providing backhauling.

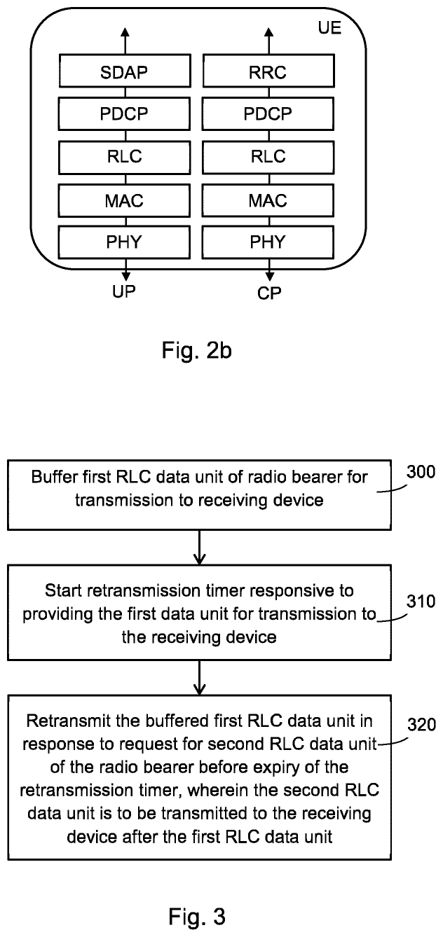

FIGS. 2a and 2b further illustrate 5G NR protocol architecture for gNB and UE, respectively. CU provides support for higher layers of the protocol stack (i.e., non-real time operations) and there is a single CU for each gNodeB. DU provides support for the lower layers of the protocol stack, i.e., real time L1and L2scheduling functions. Multiple DUs may be connected to each CU. The DUs are connected to the CU via F1-C and F1-U interfaces for control plane (CP) and user plane (UP), respectively. CU-UP comprises service adaptation protocol (SDAP) and packet data convergence protocol (PDCP) functions and CU-CP comprises radio resource control (RRC) and PDCP functions. Corresponding UE UP and CP protocol layers (and protocol entities) are illustrated in FIG. 2b.

A radio link control (RLC) sublayer and protocol entity can be configured to perform data transfer in a transparent mode (TM), in an unacknowledged mode (UM), or in an acknowledged mode (AM), as further defined in 3GPP specification TS38.300, section 6.3. The services of the RLC sublayer depend on the transmission mode. TM and UM mode have a separate RLC entity for transmitting and receiving, whereas AM mode includes only a single RLC entity that performs both transmitting and reception functionalities. An RLC header is added in UM and AM transmission modes to an RLC service data unit (SDU) to construct an RLC protocol data unit (PDU) for MAC layer transmission. In the UM and AM transmission modes, an RLC SDU may be segmented and transported using two or more RLC PDUs. Error correction is performed in the AM transmission mode. Retransmission of RLC SDUs or RLC SDU segments is based on RLC status reports from a receiving RLC protocol entity.

In 3GPP 5G systems quality of service (QoS) model is based on QoS flows. At the non-access stratum (NAS), packet filters in UE and CN/UPF map UL and DL packets respectively to QoS flows. At the access stratum (AS), rules in the UE and the AN map QoS flows to data radio bearers (DRBs). Multiple IP flows can be mapped to the same QoS flow. Multiple QoS flows can be mapped to a single DRB. Each QoS flow has a QoS profile that includes QoS parameters and QoS characteristics. QoS flows are controlled by SMF. SMF associates a QoS flow with QoS profile, QoS rules and packet detection rules (PDRs). QoS flows are preconfigured or created/updated via PDU Session Establishment or Modification procedure. For example, QoS characteristics include priority level, packet delay budget (PDB), and packet error rate (PER).

For example, conversational voice may have 100 ms PDB and 0.01 PER. XR traffic may require as low as 10 ms PDB, and reliability requirement as high as between 95% and 99.9%. Because high reliability requirements cannot be met without performing retransmissions in a resource efficient manner, XR services need to rely on RLC level retransmissions.

In automatic repeat request (ARQ) methods, if the transmitting protocol entity does not receive an acknowledgment before the timeout, it retransmits the packet until it receives an acknowledgment or exceeds a predefined number of retransmissions. Hybrid automatic repeat request (HARQ) is a combination of high-rate forward error correction (FEC) and ARQ error-control. HARQ retransmissions alone are not always enough for capacity hungry services like XR, and thus ARQ retransmissions may also be needed.

For example, it may be desirable that an initial first transmission uses a block error rate (BLER) target of e.g. 10%. If HARQ fails, e.g. after two HARQ transmissions, this triggers ARQ retransmission that allows selecting another modulation and coding scheme (MCS) for the transmission that better fits experienced signal to interference plus noise ratio (SINR) conditions at the receiver. For example, it may happen that the selection of the MCS for initial transmission was far off, e.g. due to channel quality indicator (CQI) measurement imperfections, and hence continuing with HARQ would not lead to successful decoding at the receiver side. A problem is that the RLC AM transmission mode does not provide small enough PDB needed for services like XR. Retransmissions are triggered in the transmitter by status reports received from the receiver. This may not be fast enough, particularly when the traffic is bursty in nature. Further, the RLC protocol entity does not give up on retransmitting a packet and if the maximum number of retransmissions is reached for a packet, the RLC protocol entity notifies upper layers, which triggers a radio link failure (RLF).

If, for example, only one ARQ retransmission is possible (according to applied/allowed PDB) RLC will not stop retransmitting whenever that one retransmission is not enough. This may lead to undesired RLF since the maximum number of retransmissions is due to PDB rather than channel conditions. Another issue is that the additional retransmissions occupy the transmission path and prevent new PDUs from being transmitted.

There are now provided improvements for arranging retransmissions, facilitating improved latency for services with small PDB, such as XR services. A retransmission timer is applied to arrange RLC level transmissions.

FIG. 3 is a flow graph of a method for controlling retransmissions in accordance with at least some embodiments. A transmitting communications device or apparatus, such as the UE 10, the AN 20 (in some embodiments gNB or gNB-DU), or a controlling apparatus configured to control the functioning thereof, may be configured to perform the method, when communicating with a receiving (radio access) device, such as the AN 20 or the UE 10. It is to be noted that an action, such as transmitting, in a given block of any of the methods disclosed herein may refer to controlling or causing such action in another apparatus or unit.

Block 300 comprises buffering a first radio link control, RLC, data unit of a radio bearer for transmission to a receiving device.

Block 310 comprises starting a retransmission timer responsive to providing the first data unit for transmission to the receiving device.

Block 320 comprises retransmitting the buffered first RLC data unit in response to a request for a second RLC data unit of the radio bearer before expiry of the retransmission timer, wherein the second RLC data unit is to be transmitted to the receiving device after the first RLC data unit.

The retransmission may thus be triggered without receiving a negative acknowledgement (or a status indication/report) from the receiving device and in response to non-expiry of the retransmission timer. The retransmission may be triggered instantly upon receiving a request of a lower protocol layer, such as the 5G NR MAC layer entity, for next data unit, such as 5G NR RLC PDU, of the radio bearer (and associated QoS flow) for transmission. The radio bearer may refer generally to a data carrier over a radio interface, such as a DRB of a 3GPP-based system. When the MAC entity, after having transmitted the first PDU, requests a new PDU from an RLC entity while the retransmission timer is running, the RLC entity may thus again provide the previously transmitted first PDU, instead of the subsequent (second) PDU. Since the retransmission is arranged based on the lower layer request and the retransmission timer instead of being triggered by a status report from the receiving device, the delay for retransmitting the first data unit may be substantially reduced (as compared to AM retransmission triggered upon receiving the NACK from the receiving device).

The method of FIG. 3 may be performed and the retransmission may be triggered in an existing or a new RLC mode or state, which may be other than an acknowledged mode of operation. Thus, the method of FIG. 3 and the retransmission may be performed by an RLC entity other than the RLC AM entity. In some embodiments, the method of FIG. 3 and the retransmission are performed in unacknowledged RLC mode of operation, such as the NR RLC UM by a transmitting RLC UM protocol entity. However, the method of FIG. 3 and the retransmission may be performed in another non-AM RLC mode and entity, such as a new RLC mode and entity. Such new RLC mode and parameters thereof may be optimized for XR type of communication, for example.

The retransmission timer is other than a timer applied in the RLC AM, triggering retransmission in case of no response (Ack or Nack) from the peer RLC entity (within the time period set by the timer). Buffering may refer generally to temporarily storing one or more data units, in a buffer or queue, to enable subsequent retransmission of the data units. The RLC data unit may be buffered in block 300 into a buffer, which is other than the retransmission buffer for 3GPP NR RLC AM entity. The RLC data units may be NR RLC PDUs. The apparatus may be configured to perform the method and start a retransmission timer in block 320 for each SDU or a last segment of each SDU included in the RLC PDU of the radio bearer.

The apparatus performing the method may be configured to perform further intermediary block(s), between blocks 310 and 320, of receiving the request (for the second RLC data unit) and checking status of the retransmission timer. In some embodiments, the receiving and the checking are consecutive steps. Thus, the status of the retransmission timer may be checked in response to the reception of the request. If outcome of the checking step is that the retransmission timer has not expired, block 320 is entered.

If the retransmission timer has expired, retransmission of the data unit(s) associated with the retransmission timer is prevented. The apparatus may be configured to, in response to the expiry of the retransmission timer, discard the buffered first RLC data unit without triggering an RLC failure. Thus, the buffered data unit may be deleted from the buffer upon detecting the expiry of the retransmission timer, and the method may be repeated for a subsequent RLC data unit. In addition or alternatively to the specific check of the retransmission timer, the apparatus may be configured to periodically check the status of the retransmission timer or detect expiry of the retransmission timer (resulting to prevent entering block 320).

An RRC protocol entity of the apparatus may configure the retransmission timer for each logical channel, or radio or RLC bearer, such as the 5G NR RLC bearer/DRB. The retransmission timer may be configured based on received QoS information or profile, associated with the radio bearer. Received QoS information, such as the PDB, or associated message may trigger the apparatus to perform the method of FIG. 3 and/or set retransmission timer related operation parameter(s), such as the timer value, i.e. a time period during which the timer is running before expiry. In some example embodiments, the retransmission timer is configured according to a packet delay parameter, such as the PDB. The PDB may be received from the CN 30. The PDB may be included in a received QoS profile of the QoS flow associated with the DRB. In case of 3GPP 5G systems, the PDB may be received from the SMF (via AMF).

RLC data units may be concatenated and multiple RLC data units (including the first RLC data unit) of the radio bearer may be included in a single transport block. For example, multiple RLC PDUs of a QoS flow may be included in a single transport block for XR service, in view of the high data rate requirements for XR services. The MAC protocol entity may be configured to request another RLC PDU after the first RLC PDU from the RLC protocol entity, to fill the same transport block. When the retransmission timer is already running for the first RLC PDU, the same first RLC PDU would be considered again. To avoid this situation, the apparatus may be configured to perform further block(s) between blocks 300 and 310 to cause a delay for starting the retransmission timer for the first RLC PDU. Some embodiments for addressing such cases are illustrated below.

In some embodiments, an additional delay timer is applied to control starting/activation of the retransmission timer in block 310.

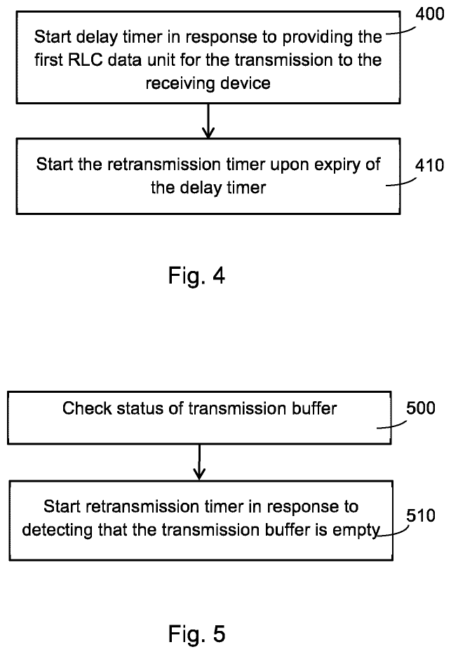

FIG. 4 is a flow graph of a method for controlling the retransmission timer activation in accordance with at least some embodiments. A transmitting communications device or apparatus, such as the UE 10, the AN 20 (in some embodiments gNB or gNB-DU), or a controlling apparatus configured to control the functioning thereof, may be configured to perform the method.

The apparatus may be configured to start 400 a delay timer after buffering 300 the first RLC and responsive to providing the first RLC data unit for the transmission to the receiving device. Block 410 comprises starting the retransmission timer upon expiry of the delay timer.

Block 400 may be entered upon the RLC entity providing the first RLC data unit to the MAC entity. The delay timer may thus delay the point in time when the retransmission timer is started (310) for an SDU, i.e. the delay timer sets the starting point from when an SDU is fed for retransmission.

An RRC entity of the apparatus may configure the delay timer for each logical channel, or radio or RLC bearer, such as a 5G NR RLC bearer. The delay timer may be set based on time it would typically take for a gNB to decide whether a retransmission is required and should be at least as long as an HARQ round trip time (RTT), i.e. time interval between initial transmission and retransmission.

In some embodiments, empty transmission buffer is applied as a precondition for entering block 310. With reference to FIG. 5, the apparatus may thus be configured to check 500 status of a (layer 2) transmission buffer, such as the 5G NR RLC transmission buffer, after block 300. The apparatus may be configured to start 510 the retransmission timer (and enter block 310) in response to detecting that the transmission buffer is empty.

Data may arrive for transmission into a transmission buffer in bursts. Upon initial transmission of the RLC data units of the radio bearer (including the first RLC data unit), the RLC data units may be stored or placed in a specific retransmission queue. This may be performed in connection with block 300. The apparatus may be configured to activate retransmission of the RLC data units from the retransmission queue in response to the detecting that the transmission buffer is empty.

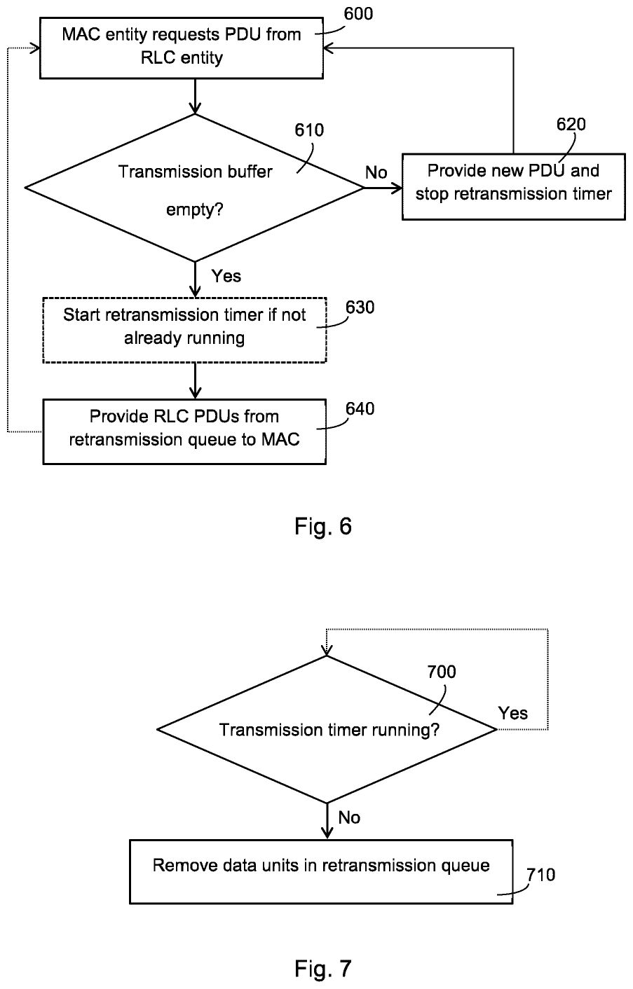

FIG. 6 is a flow graph of a method, applying the retransmission queue and the transmission buffer check, in accordance with at least some embodiments, which may be applied in connection with the method of FIG. 3. A transmitting communications device or apparatus, such as the UE 10, the AN 20 (in some embodiments gNB or gNB-DU), or a controlling apparatus configured to control the functioning thereof, may be configured to perform the method.

When the request of the MAC protocol entity for new PDU(s) is detected 600, the apparatus performing the method, or an RLC protocol entity thereof, may check 610 the status of the L2 or RLC level transmission buffer. If it is not empty, new RLC PDU(s) may be provided 620 to the MAC layer. If the retransmission timer is active, it may be stopped in block 620. If the RLC level transmission buffer is empty, the retransmission timer may be started 630 and the retransmission queue may become active. Thus, the RLC PDU(s) stored in the retransmission queue are retransmitted 640 to the MAC layer. The method may then proceed to wait for a subsequent request from the MAC protocol entity. These features enable similar effect as the delay timer. PDUs remain in the retransmission queue for as long as the retransmission timer runs. Then, when the MAC protocol entity asks for another PDU from the RLC entity and the transmissions buffer(s) are empty, the data units in the retransmission queue are retransmitted.

The apparatus may be configured to prioritize PDUs buffered in the retransmission queue over new SDUs to accommodate for a configuration where there is a possible overlap between retransmission timer expiry and new data arriving early due to jitter. Alternatively, arrival of new SDUs may cause emptying or flushing the retransmission queue. An explicit configuration, for example via RRC signaling, may be transmitted to the UE and may indicate to the UE which of these options to follow. For example, to address situations where there is large jitter, the network (e.g. the gNB in case of 3GPP NR system) may control the UE to priorities the retransmission queue for as long as it includes data, to maximize the chances of retransmissions. For cases where the jitter is short but the network would still configure a retransmission timer as large as possible, emptying or flushing the retransmission queue upon receiving new data units for transmission may be preferred and UE accordingly controlled.

Instead of having a retransmission timer for each RLC data unit, the retransmission timer may be arranged for a plurality of RLC data units of the data bearer being transmitted. In an example embodiment, a retransmission timer is started for the whole retransmission queue, i.e. a plurality of data units stored in the queue. Such (queue-specific) retransmission timer, which may also be referred to as a queue timer, retransmission queue timer or queue retransmission timer, may be started in block 530 or 540 when the retransmission queue becomes active, i.e. when the transmission buffers are empty. As further illustrated in FIG. 7, status of such retransmission timer is repeatedly checked, for example as part of the method of FIG. 3 or FIG. 5. Upon expiry of the transmission timer, all RLC PDUs are removed or flushed from the retransmission queue. If the retransmission timer is not expired, PDUs in the queue may be retransmitted from the retransmission queue, as illustrated earlier.

In some embodiments, at least some of the presently disclosed features are applied for 5G NR systems. Some further such example embodiments have been illustrated above with references to NR entities, without however limiting application of the features to such systems and entities. At least some of the presently disclosed features may be applicable also in other radio access systems, such as 6G systems.

Presently disclosed features, based on the method of FIG. 3, enable that RLC retransmissions can quickly take place at the transmitter without status reports from the receiver, while avoiding complex interaction between MAC and RLC entities. The MAC protocol entity may remain unaware of the exact content of each RLC PDUs and the RLC protocol entity does not need to care about logical channel prioritization (LCP). The features can be implemented on top of 3GPP NR RLC UM, for example.

A substantial advantage is also that specialized new functionality is not required in the receiver, as duplicate detection in the receiver, in 5G NR by PDCP entity, can simply discard duplicates in case of HARQ feedback error.

The present features may be applied for data delivery of various XR applications. However, in addition to or instead of XR, the features can be used for any traffic which may be bursty in nature and for which a small number of RLC retransmissions, such as 1 to 3 retransmissions, would be possible.

An electronic device comprising electronic circuitries may be an apparatus for realizing at least some embodiments of the present invention. The apparatus may be or may be comprised in a computer, a user device/equipment, a base station, access point device, a RAN element or node, a RAN controller, or another apparatus capable for at least controlling RLC level data transmission. In another embodiment, the apparatus carrying out at least some of the above-described functionalities is comprised in such a device, e.g. the apparatus may comprise a circuitry, such as a chip, a chipset, a microcontroller, or a combination of such circuitries in any one of the above-described devices.

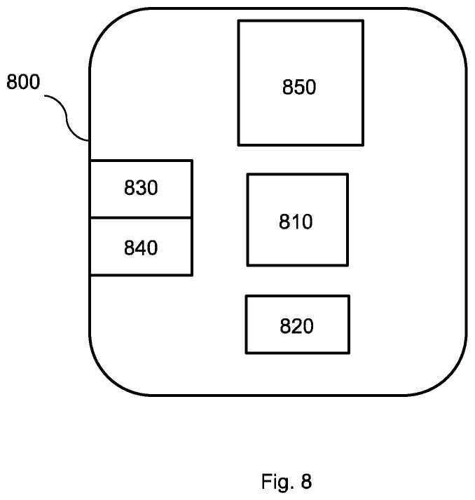

FIG. 8 illustrates an example apparatus capable of supporting at least some embodiments. Illustrated is device 800, which may comprise, for example, in applicable parts, a physical device running the UE 10, the AN 20, such as the CU 22 or DU 24, 26, for example. The device may be configured to operate as the apparatus performing the method of FIG. 3, 4, 5, 6, 7, or an embodiment thereof.

Comprised in device 800 is processor 810, which may comprise, for example, a single-or multi-core processor wherein a single-core processor comprises one processing core and a multi-core processor comprises more than one processing core. Processor 810 may comprise, in general, a control device. Processor 810 may comprise more than one processor. Processor 810 may be a control device. Processor 810 may comprise at least one application-specific integrated circuit, ASIC. Processor 810 may comprise at least one field-programmable gate array, FPGA. Processor 810 may be means for performing method steps in device 800, such as receiving, transmitting and/or providing, for example. Processor 810 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory(ies) that work together to cause an apparatus, such as a server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 800 may comprise memory 820. Memory 820 may comprise random-access memory and/or permanent memory. Memory 820 may comprise at least one RAM chip. Memory 820 may comprise solid-state, magnetic, optical and/or holographic memory, for example. Memory 820 may be at least in part accessible to processor 810. Memory 820 may be at least in part comprised in processor 810. Memory 820 may be means for storing information. Memory 820 may comprise computer instructions that processor 810 is configured to execute. When computer instructions configured to cause processor 810 to perform certain actions are stored in memory 820, and device 800 overall is configured to run under the direction of processor 810 using computer instructions from memory 820, processor 810 and/or its at least one processing core may be considered to be configured to perform said certain actions. Memory 820 may be at least in part comprised in processor 810. Memory 820 may be at least in part external to device 800 but accessible to device 800.

Device 800 may comprise a transmitter 830. Device 800 may comprise a receiver 840. Transmitter 830 and receiver 840 may be configured to transmit and receive, respectively, information in accordance with at least one cellular or non-cellular standard. Transmitter 830 may comprise more than one transmitter. Receiver 840 may comprise more than one receiver. Transmitter 830 and/or receiver 840 may be configured to operate in accordance with a suitable messaging protocol.

Device 800 may comprise user interface, UI, 850. UI 850 may comprise at least one of a display, a keyboard and a touchscreen. A user may be able to operate device 800 via UI 850, for example to configure operating parameters, such as parameter affecting an operation of the above described method.

Processor 810 may be furnished with a transmitter arranged to output information from processor 810, via electrical leads internal to device 800, to other devices comprised in device 800. Such a transmitter may comprise a serial bus transmitter arranged to, for example, output information via at least one electrical lead to memory 820 for storage therein. Alternatively, to a serial bus, the transmitter may comprise a parallel bus transmitter. Likewise, processor 810 may comprise a receiver arranged to receive information in processor 810, via electrical leads internal to device 800, from other devices comprised in device 800. Such a receiver may comprise a serial bus receiver arranged to, for example, receive information via at least one electrical lead from receiver 840 for processing in processor 810. Alternatively, to a serial bus, the receiver may comprise a parallel bus receiver. Device 800 may comprise further devices not illustrated in FIG. 8. In some embodiments, device 800 lacks at least one device described above.

Processor 810, memory 820, transmitter 830, receiver 840 and/or UI 850 may be interconnected by electrical leads internal to device 800 in a multitude of different ways. For example, each of the aforementioned devices may be separately connected to a master bus internal to device 800, to allow for the devices to exchange information. However, as the skilled person will appreciate, this is only one example and depending on the embodiment various ways of interconnecting at least two of the aforementioned devices may be selected without departing from the scope of the present invention.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

1-22. (canceled)

23. An apparatus, comprising one or more processors and memory comprising instructions, when executed by the one or more processors, cause the apparatus to perform:
buffering a first radio link control (RLC) data unit of a radio bearer for transmission to a receiving device,
starting a retransmission timer responsive to providing the first RLC data unit for transmission to the receiving device, and
retransmitting the buffered first RLC data unit in response to a request for a second RLC data unit of the radio bearer before expiry of the retransmission timer, wherein the second RLC data unit is to be transmitted to the receiving device after the first RLC data unit.

24. The apparatus of claim 23, wherein the apparatus is configured to perform:
triggering the retransmission of the buffered first RLC data unit to the receiving device in response to receiving the request for the second RLC data unit from a medium access control (MAC) protocol entity before the expiry of the retransmission timer, and
providing the buffered first RLC data unit to the MAC protocol entity instead of the second RLC data unit.

25. The apparatus of claim 23, wherein the apparatus is configured to perform discarding the buffered first RLC data unit without triggering a radio link failure in response to expiry of the retransmission timer.

26. The apparatus of claim 23, wherein the apparatus is configured to perform said buffering, said starting, and said retransmission in an unacknowledged transmission mode.

27. The apparatus of claim 23, wherein the RLC data units are RLC protocol data units (PDUs) and the apparatus is configured to start a retransmission timer for each service data unit or a last segment of each service data unit included in an RLC PDU of the radio bearer.

28. The apparatus of claim 23, wherein the apparatus is configured to perform:
starting a delay timer in response to providing the first RLC data unit for the transmission to the receiving device, and starting the retransmission timer upon expiry of the delay timer.

29. The apparatus of claim 23, wherein multiple RLC data units of the radio bearer are included in a transport block, and the apparatus is configured for starting the retransmission timer in response to detecting that an RLC level transmission buffer is empty.

30. The apparatus of claim 29, wherein the apparatus is configured for storing the RLC data units in a retransmission queue upon initial transmission of the RLC data units and activating retransmission of the RLC data units from the retransmission queue in response to the detecting that the RLC level transmission buffer is empty.

31. The apparatus of claim 30, wherein the apparatus is configured for
starting the retransmission timer for the retransmission queue in response to the detecting that the RLC level transmission buffer is empty, and
discarding the data units in the retransmission queue in response to expiry of the timer.

32. The apparatus of claim 23, wherein the apparatus is configured for configuring the retransmission timer for the radio bearer by a radio resource control entity according to a packet delay parameter, such as a packet delay budget, assigned for a quality of service flow associated with the radio bearer.

33. A method, comprising:
buffering a first radio link control (RLC) data unit of a radio bearer for transmission to a receiving device,
starting a retransmission timer responsive to providing the first RLC data unit for transmission to the receiving device, and
retransmitting the buffered first RLC data unit in response to a request for a second RLC data unit of the radio bearer before expiry of the retransmission timer, wherein the second RLC data unit is to be transmitted to the receiving device after the first RLC data unit.

34. The method of claim 33, wherein an RLC protocol entity:
triggers the retransmission of the buffered first RLC data unit to the receiving device in response to receiving the request for the second RLC data unit from a medium access control (MAC) protocol entity before the expiry of the retransmission timer, and
provides the buffered first RLC data unit to the MAC protocol entity instead of the second RLC data unit.

35. The method of claim 33, comprising: discarding the buffered first RLC data unit without triggering a radio link failure in response to expiry of the retransmission timer.

36. The method of claim 33, wherein a transmitting unacknowledged mode RLC entity performs said buffering, said starting, and said retransmission.

37. The method of claim 33, wherein the RLC data units are RLC protocol data units (PDUs) and the retransmission timer is started for each service data unit or a last segment of each service data unit included in an RLC PDU of the radio bearer.

38. The method of claim 33, comprising:
starting a delay timer in response to providing the first RLC data unit for the transmission to the receiving device, and
starting the retransmission timer upon expiry of the delay timer.

39. The method of claim 33, wherein multiple RLC data units of the radio bearer are included in a transport block, and the retransmission timer is started in response to detecting that an RLC level transmission buffer is empty.

40. The method of claim 39, comprising:
storing the RLC data units in a retransmission queue upon initial transmission of the RLC data units, and
activating retransmission of the RLC data units from the retransmission queue in response to the detecting that the RLC level transmission buffer is empty.

41. The method of claim 40, comprising:
starting the retransmission timer for the retransmission queue in response to the detecting that the RLC level transmission buffer is empty, and
discarding the data units in the retransmission queue in response to expiry of the timer.

42. The method of claim 33, comprising: configuring the retransmission timer for the radio bearer by a radio resource control entity according to a packet delay parameter, such as a packet delay budget, assigned for a quality of service flow associated with the radio bearer.
